(19) United States
(12) Patent Application Publication
(10) Pub. No.: US 2026/0170018 A1
(43) Pub. Date: Jun. 18, 2026

(54) GENERATING GROUND TRUTH LABELING FOR ENTITY RESOLUTION

(71) Applicant: Oracle International Corporation, Redwood Shores, CA (US)

(72) Inventors: Constantin Nicolae, Schneisingen (CH); Lukas Gelbmann, Zurich (CH); Ljupche Milosheski, Zurich (CH); Gojko Cutura, Zurich (CH); Edoardo Stoppa, Giussano (IT); Douglas Harris, Danville, CA (US); Rhicheek Patra, Zurich (CH); Sungpack Hong, Palo Alto, CA (US); Hassan Chafi, Zurich (CH); Marouane Maatouk, Casablanca (MA)

(21) Appl. No.: 18/978,199

(22) Filed: Dec. 12, 2024

(51) Int. Cl. G06F 16/28; G06F 16/215; G06F 16/2455

(52) U.S. Cl. CPC G06F 16/288; G06F 16/215; G06F 16/24558

(57) ABSTRACT

A method receives a dataset of records as an input. The method executes a labeling procedure that outputs a matched dataset of the received dataset, the matched dataset including functionally matched pairs of records, where a matching function determines that each functionally matched pair of records represent a respective same entity. The method determines transitive pairs of records including a first record and a second record that belong to a same entity based on the first record and a third record being one of the functionally matched pairs of records representing the same entity and based on the second record and the third record being another of the functionally matched pairs of records representing the same entity. The method labels the transitive pairs of records and functionally matched pairs of records as matched pairs of records based on the records belonging to the same respective entity. The method outputs the labeled matched pairs of records.

### FIELD

The present invention relates to entity resolution data gathering and, more specifically, to producing ground truth labeling for use in entity resolution tasks.

### BACKGROUND

The main purpose of entity resolution is to relate a collection of records to entities. An entity may be, for example, a person, a company, a publication, or any other entity. A collection of records, which may come from one or more data sources, forms a dataset. A single record contains one or more attributes, such as a name, a date of birth, an address, or a numerical ID. Records may be part of one or more data sources, and it is not known a priori which entity or entities they refer to.

Entity resolution refers to reconciling which records belong to which entities. It involves several closely related tasks, including record linkage and deduplication. Record linkage is the task of determining which records across two or more data sources refer to the same entity. Deduplication is the task of determining which records of a single data source refer to the same entity. The output of both record linkage and deduplication can be seen as clusters of records that relate to the same entities.

Entity resolution is a non-trivial task for multiple reasons. One reason is some attributes may be nullable in that they may not have a known value. Another reason is that attribute correctness is not guaranteed due to simple human error or data corruption. Errors can be minor, such as misspellings, or major, such as accidentally using a value that belongs to a different record. Another reason entity resolution is a non-trivial task is in some cases, multiple different attribute values can be correct for a given entity. For example, a person can have multiple telephone numbers. Another reason entity resolution is a non-trivial task is different variations of the same attribute value can exist, such as due to different spellings of the same word, use of different languages, use of different date conventions, etc.

The approaches described in this section are approaches that could be pursued, but not necessarily approaches that have been previously conceived or pursued. Therefore, unless otherwise indicated, it should not be assumed that any of the approaches described in this section qualify as background merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In order to describe the manner in which advantages and features of the disclosure can be obtained, a description of the disclosure is rendered by reference to specific embodiments thereof which are illustrated in the appended drawings. These drawings depict only example embodiments of the disclosure and are not therefore to be considered to be limiting of its scope. The drawings may have been simplified for clarity and are not necessarily drawn to scale.

FIG. 1 is an example illustration of a procedure for providing ground truth labeling according to an illustrative embodiment.

FIG. 2 is an example illustration of results of a labeling procedure using a maximum number of hops according to an illustrative embodiment.

FIG. 3 is an example illustration of an algorithm for computing transitive closure according to an illustrative embodiment.

FIG. 4 is an example illustration of an algorithm for computing a labeling with a max_hops parameter according to an illustrative embodiment.

FIG. 5 is an example illustration of pseudocode for a matching function according to an illustrative embodiment.

FIG. 6 is an example illustration of an algorithm for building an index according to an illustrative embodiment.

FIG. 7 is an example illustration of results of a labeling procedure according to an illustrative embodiment.

FIG. 8 is an example illustration of results of a labeling procedure according to an illustrative embodiment.

FIG. 9 is an example illustration of relevant attributes of datasets according to an illustrative embodiment.

FIG. 10 is an example illustration of an algorithm for a FEBRL3 matching function according to an illustrative embodiment.

FIG. 11 is an example illustration of an algorithm for a MusicBrainz matching function according to an illustrative embodiment.

FIG. 12 is an example illustration of an algorithm for a less strict MusicBrainz matching function according to an illustrative embodiment.

FIG. 13 is a block diagram that illustrates a computer system upon which aspects of the illustrative embodiments may be implemented.

FIG. 14 is a block diagram of a basic software system that may be employed for controlling the operation of a computer system to implement aspects of the illustrative embodiments.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

The illustrative embodiments provide an automatic procedure to produce a ground truth labeling for use in entity resolution tasks. Embodiments can further provide for entity resolution data gathering. In a possible embodiment, a method can automatically produce labeled pairs of records from an unlabeled dataset in the area of entity resolution. The method can use a record matching function that is run by a computer. The labeled pairs can be used, for instance, for machine learning, for estimating the accuracy of entity resolution algorithms, and for other purposes.

A labeling contains pairs of records that are believed to refer to the same entity, such as the same person in the real world. These pairs are given a positive label. Optionally, a labeling may also contain a set of pairs of records that are believed to refer to different entities. These pairs are given a negative label. A labeling may also optionally assign additional attributes to each pair of records.

A labeling can be full or partial. In a full labeling, every possible pair of records is labeled with a positive label or a negative label. There are on the order of N² possible pairs of records, with N being the number of records. Pairs with negative labels need not be explicitly stored in a full labeling, because in a full labeling, a negative label can be inferred from the absence of a positive label. On the other hand, a partial labeling does not claim anything about the absent pairs. Pairs with negative labels must be stored explicitly in a partial labeling.

Ground truth labeling is defined as a partial labeling of pairs of records. The ground truth labeling is produced with a particular aim to minimize the number of false positive pairs. False positive pairs are pairs that have a positive label, but actually do not refer to the same entity. False positive pairs can create a bigger issue than false negative for entity resolution because false negative pairs of records will only result in missing a pair of records that belong to the same entity, where false positive pairs of records will link two records that do not actually belong to the same real-world entity.

Embodiments produce a ground truth labeling, which, for readability, will be referred to simply as “labeling.” The task of producing a ground truth labeling can differ from both record linkage and deduplication. The main difference is that producing a ground truth labeling does not usually aim for completeness, as the labeling can be a partial labeling. For example, functionally matched and transitive pairs of records can be produced with high confidence that they belong to the same entity without necessarily finding all records that belong to the same entity. To the contrary, in record linkage and deduplication, completeness is usually important. Thus, the labeling alone may not provide a complete set of paired records for record linkage or deduplication.

Ground truth labeling can be used for several purposes. One purpose is for estimating the accuracy of a method performing entity resolution, such as record linkage or deduplication. Another purpose is for choosing a method to perform an entity resolution task according to estimated accuracy of different methods. Another purpose is for choosing parameters or hyperparameters for a method performing entity resolution according to estimated accuracy. Another purpose is for optimizing parameters through supervised machine learning methods in the context of entity resolution. Ground truth labeling can also be used for other purposes that are apparent to those skilled in the art.

At least some embodiments provide solutions to the problem of producing a partial labeling that is usable as ground truth data from an unlabeled dataset. Embodiments provide a method for producing a labeling for records from an input dataset of unlabeled records. The method uses transitive closure for data labeling. The method employs transitive closure to ensure that all relevant relationships between records are captured into corresponding clusters, thereby augmenting the output labeling with pairs of records that could not be easily found otherwise. For example, the method produces transitive pairs of records based on functionally matched pairs of records and outputs all the pairs of records labeled as matched pairs of records belonging to the same entity.

An example method includes receiving a dataset of records as an input. The received dataset includes unlabeled records, such as records that are not labeled as matching the same entity. A matching function determines functionally matched pairs of records based on pairs of records representing a respective same entity. The matching function can determine the functionally matched pairs of records based on at least one attribute of a one record matched pair matching an attribute of the other record of the matched pair, based on pattern matching of the records, based on a maximum Levenshtein distance between records, and based on other matching functions. The matching function outputs a Boolean value indicating a functional match or non-match of a pair of records from the received dataset. The labeling procedure outputs a matched dataset of the received dataset, where the matched dataset includes functionally matched pairs of records. The matched dataset includes positive match indications for each matched pair of records that belong to the same entity.

The method determines transitive pairs of records including a first record and a second record that belong to a same entity based on the first record and a third record being one of the functionally matched pairs of records representing the same entity and based on the second record and the third record being another of the functionally matched pairs of records representing the same entity. For example, a relation is transitive if, whenever it relates record A to record B and record B to record C, it also relates record A to record C. This can ensure that indirect matches are accounted for by identifying indirect relationships between records based on direct relationships. Given a set of records and a relation that defines which pairs of records are matched, a strict transitive closure is the smallest set of pairs that includes all direct matches and ensures that if record A is matched with record B, and record B is matched with record C, then record A is also matched with record C. A reflexive transitive closure includes pairs of records matched with themselves.

A generally matched pair includes pairs matched by the matching function or matched by the transitive process. Pairs matched by the matching function are functionally matched pairs and pairs matched by the transactive property are transitive pairs. Functionally matched pairs are matched based on comparing attributes of the records. Transitive pairs are matched based on the transitive property, which relies on two functionally matched pairs.

The method labels the transitive pairs of records and functionally matched pairs of records as matched pairs of records based on the records belonging to the same respective entity. The method then outputs the labeled matched pairs of records.

In an embodiment, a maximum number of hops value is optionally stored and the transitive pairs of records are optionally limited to pairs of records that are that are connected by a number of matched pairs of records that is at most the maximum number of hops value. The stored maximum number of hops value can be predetermined, selected by a user, or otherwise provided.

The method uses a pluggable match function and an input. The match function can be tailored to specific use cases and domains. This flexibility enables the method to generalize to various applications and adapt to changing requirements. The pluggable matching function provides generalizability across different shapes of records. For example, the pluggable matching function allows the method to accommodate records with varying numbers of attributes, including those with missing or additional attributes. This flexibility ensures that the method can handle complex real-world scenarios where data may be incomplete or inconsistent.

An option can be provided to a user for selection of the pluggable matching function and an input can be received that selects the matching function. The received input can be a selection among presented matching functions and/or can be a selection of an externally provided, such as a user-provided, matching function.

In an embodiment, an estimated accuracy of a machine learning entity resolution algorithm is based on the labeled matched records. The estimated accuracy can be used to choose a method to perform an entity resolution task, to choose parameters for the method performing entity resolution algorithm, and for other purposes. Choosing parameters can include optimizing parameters, such as through machine learning methods, where the parameters can be hyperparameters.

The transitive pairs of records can include multiple-hop transitive pairs of records including a fourth pair of records determined to belong to the same entity based on multiple hops along a matched record chain. The matched record chain includes matched pairs of records that belong to the same entity and at least one transitive pair of records that belong to the same entity. Then at least one transitive pair of records is different from the fourth pair of records. For example, any transitive pair is ultimately based on two functionally matched pairs. Multiple hops can be made across three or more matched pairs, which can include at least one transitive pair. Thus, a multi-hop transitive pair can be based on a chain including two functionally matched pairs and one intervening transitive pair transitively matched based on the two functionally matched pairs.

In a possible embodiment, the method includes selecting, from the dataset of records, pairs of records that are not matched pairs of records matched in the transitive pairs of records and the functionally matched pairs of records. A negative label can be assigned to the selected pairs records indicating the selected pairs of records are not matched pairs of records. A desired ratio of positive labels to negative labels can be added as a parameter to the procedure. For example, other parameters can be adjusted to achieve a desired ratio.

The method allows for generalizability across data modalities. The method supports working with diverse types of data modalities within records, such as textual, numeric, categorical, structured, image-based, and more.

Embodiments can provide various benefits. For example, embodiments can provide ground truth data generation. By leveraging properly defined (i.e. less permissive) matching functions, the method generates a high-precision labeling of unlabeled records. These labels can be used as ground truth labels and serve as a reliable foundation for entity resolution tasks.

Embodiments can also provide a fully automated approach that requires no human intervention, making it efficient and cost-effective. The absence of manual labeling saves time and reduces the risk of errors.

Embodiments can further reduce the computational complexity of a labeling procedure for some matching functions. A reduced complexity labeling procedure can be applied to records to produce a set of matched records, including transitively matched records. For example, comparing every pair of records requires a quadratic complexity labeling procedure. A reduced complexity labeling procedure can produce the same output as a quadratic complexity labeling procedure. This improves computational efficiency and saves both computing processing and time.

Embodiments do not require seed ground truth data. In particular, unlike other approaches, the methods can be used without any seed ground truth data, which is otherwise time-consuming and costly to obtain. This eliminates the need for additional resources and simplifies the deployment process.

Embodiments can further provide higher quality labeling through domain-specific expert knowledge. By leveraging domain-specific expert knowledge, the methods generate higher-quality labeling that is tailored to specific domains and use cases. This expertise ensures the methods produces accurate and relevant results, even in complex and nuanced applications.

Embodiments can additionally provide a highly customizable process that uses a matching function that can be defined for specific use cases, including different modalities (e.g. images, text, and other modalities) and record shapes.

The method improves the functioning of a computer by determining transitive pairs of records based on previously functionally matched pairs of records, labeling the transitive pairs of records as functionally matched pairs of records, and outputting the labeled matched pairs of records. This improves the efficiency of a computer by reducing the computational complexity of a labeling procedure, as described above. The method also improves database operation when performing entity resolution operations, such as record linkage and deduplication, by providing ground truth labels that serve as a reliable foundation for entity resolution, which increases database flexibility and provides faster search times. The method further addresses technical problems experienced by a database when performing entity resolution, such as problems that occur when attributes are nullable, when attributes are incorrect, when multiple attributes are correct for the same entity, and when different correct variations of a single attribute are possible.

### Labeling Matched Pairs of Records

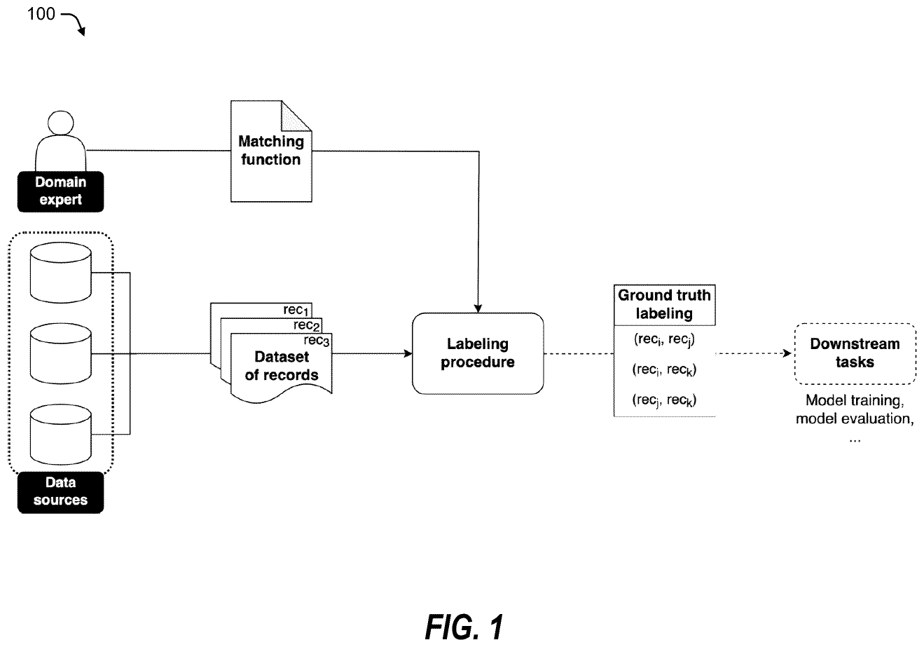

FIG. 1 is an example illustration of a procedure 100 for providing ground truth labeling according to an illustrative embodiment. Data sources are combined to produce a dataset of records. This dataset of records may have duplicate records, where some records can include misspelled information, some records may have attributes with wrong information due to errors, some records may be duplicates that refer to the same entity, etc.

### Matching Function

As a prerequisite to the procedure, a matching function is defined. The matching function outputs a Boolean value indicating a functional match or non-match of a pair of records from the received dataset. The labeling procedure outputs a matched dataset of the received dataset. The matched dataset includes functionally matched pairs of records, where the matching function determines that each functionally matched pair of records represents a respective same entity. For example, the matching function takes as input a pair of records A and B, each including one or more attributes. The matching function returns a Boolean or equivalent data type to indicate whether or not the records belong to the same entity. The matching function can be seen as a homogeneous relation over the set of records. The matching function returns TRUE if and only if the input records are believed to belong to the same entity. For example, the matching function can return TRUE with a high confidence of records belonging to the same entity and return FALSE if there is less confidence. The matching function should be symmetric, where the output applied to a pair of records (A, B) should be the same as the output for (B, A). A suitable matching function can be defined by a domain expert or otherwise defined.

### Transitive Closure

With this matching function defined, a labeling procedure computes the transitive closure of records with regards to the matching function to create a ground truth labeling of pairs of records determined to belong to the same entity. For example, the labeling procedure determines transitive pairs of records including a first record and a second record that belong to a same entity based on the first record and a third record being one of the functionally matched pairs of records representing the same entity and based on the second record and the third record being another of the functionally matched pairs of records representing the same entity. Whenever a pair of records is functionally matched as belonging the same entity, the labeling procedure applies transitive closure to not only label the functionally matched pairs, but to also label transitive pairs of records as belonging to the same entity.

To elaborate, if the matching function returns TRUE when applied to A and B, and also when applied to B and C, then each of the pairs (A, B), (A, C), and (B, C) is part of the transitive closure. Whenever a pair of records is paired in the transitive closure, the labeling procedure assigns a positive label to this pair of records. The idea behind applying the transitive closure is: if one is highly confident that A and B belong to the same entity, and highly confident that B and C belong to the same entity, then one must also be confident that A and C belong to the same entity (albeit, perhaps, to a slightly lesser degree).

Strictly speaking, the pairs (A, A), (B, B), and (C, C) are not necessarily part of the transitive closure (whether they are depends on the matching function). An implementor may choose to take the strict transitive closure. A second option is to take the reflexive transitive closure, thus automatically including these pairs from the output labeling. A third option is to always exclude these pairs, regardless of the output of the matching function.

Furthermore, pairs in the labeling may be treated as ordered pairs or unordered pairs. If the pairs are treated as ordered pairs, then (B, A), (C, A), and (C, B) should also be included in the output. If the pairs are treated as unordered pairs, then (A, B) and (B, A) are equivalent, and only one of them should be included.

The labeling procedure may take a matching function as an input, such that any matching function can be provided at runtime. Alternatively, the labeling procedure may use a statically referenced (hard-coded) matching function, such that no matching function needs to be provided at runtime.

Usually, in order to minimize the number of false positive pairs, the matching function should be conservative in its matches. In other words, the matching function should prefer false negatives over false positives and return FALSE if there is not enough information to make a confident judgement. One reason for preferring a false negative is a false negative in the matching function may not have any impact on the labeling if the pair of records is connected in the transitive closure. On the other hand, false positives in the matching function always result in false positives in the labeling.

Another reason for preferring a false negative is the labeling procedure described above, without extensions described below, never produces a negative label. False negatives in the matching function can then, at worst, result in missed opportunities for true positives in the labeling. For most use cases of the labeling, these missed opportunities are not nearly as problematic as false positives.

Another reason for preferring a false negative is there are far more negative pairs than positive pairs in typical datasets. This means that for many datasets, even a relatively small false positive rate in the matching function, such as 0.1%, can result in a labeling that contains more false positives than true positives, which is unacceptable for most use cases.

### Procedure Extensions

Other optional extensions can be implemented to the labeling procedure. Any number, zero or more, of these extensions can be applied to the labeling procedure. These extensions are described below.

### Maximum Number of Hops

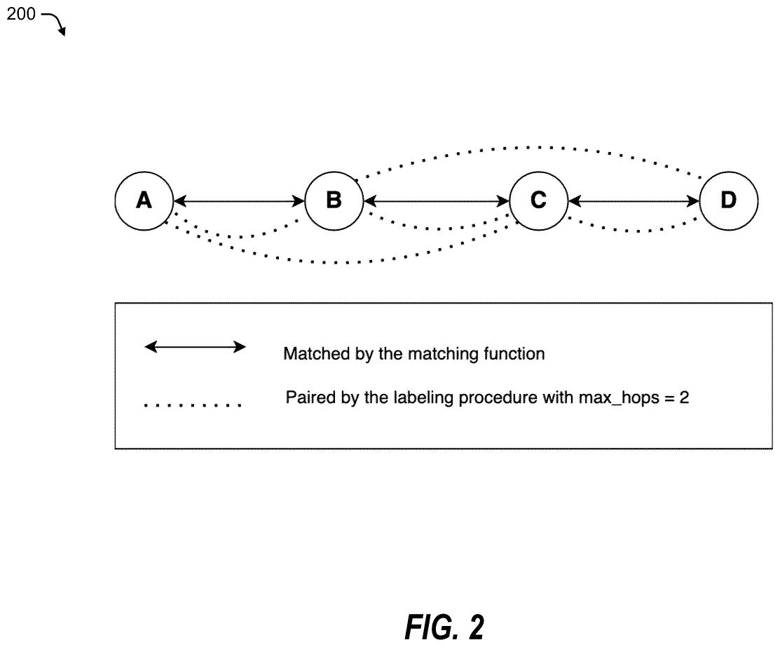

FIG. 2 is an example illustration of the results 200 of a labeling procedure using a maximum number of hops according to an illustrative embodiment. The hard lines of results 200 show the functionally matched pairs from the matching function. The dotted lines show transitive pairs from the labeling procedure using transitive closure. In this example, the labeling procedure may take a number standing for a maximum number of hops, “max_hops”, as an input. The computation of the transitive closure is then limited to pairs of records that are connected by a number of matches that is at most max_hops. For example, assume that max_hops equals 2, and the matching function returns TRUE when applied to A and B, and also when applied to B and C, and also when applied to C and D, and FALSE when applied to any other pair. In this case, each of the pairs (A, B), (A, C), (B, C), (B, D), and (C, D) is part of the output labeling. However, the pair (A, D) is not labeled positively, despite being part of the transitive closure of the matching function. This extension aims to capture the idea that the confidence of a pair decreases as the number of hops increases. At some point, the confidence is no longer high enough to justify assigning a positive label. This extension is intended to reduce the number of false positives in the output.

### Confidence Level

The labeling procedure may be extended to output a confidence level for each pair of records in the labeling. The confidence level is high if a pair of records is functionally matched by the matching function and can decrease for transitive pairs of records as a function of the number of hops used to match the records using transitive closure. The confidence level can be assigned between 0 and 1 according to a decreasing function of the number of hops. For example, if the confidence level is defined as 0.99\hat{ }num_hops, then a pair that is connected via two hops is given a confidence level of 0.99\hat{ }2. If (A, B) belong to the same entity with high confidence and (A, C) belong to the same entity with slightly lower confidence. Also, instead of, or along with, taking an input number “max_hops”, the labeling procedure can optionally take a parameter “min_confidence”, which limits the transitive closure in an equivalent way.

### Negative Labels

The output procedure described above never produces a negative label. For many use cases, it is desirable to have pairs with negative labels as well. The procedure can be extended to draw a random sample of pairs that are not part of the reflexive transitive closure and assign negative labels to them, where these records have a high likelihood of not belonging to the same entity. A desired ratio of positive labels to negative labels can be added as a parameter to the procedure. Even when the maximum number of hops or the confidence level extensions are used for limiting the number of positive labels, negative labels should still be drawn only from the pairs absent from the full reflexive transitive closure. There may be a small number of false negatives when using this extension. For typical datasets, there are far more negative pairs than positive pairs, so the number of false negatives is expected to be far smaller than the number of true negatives. A small rate of false negatives (below 2% of all negative labels) is acceptable for many use cases.

### Example Algorithms

### Labeling Algorithm

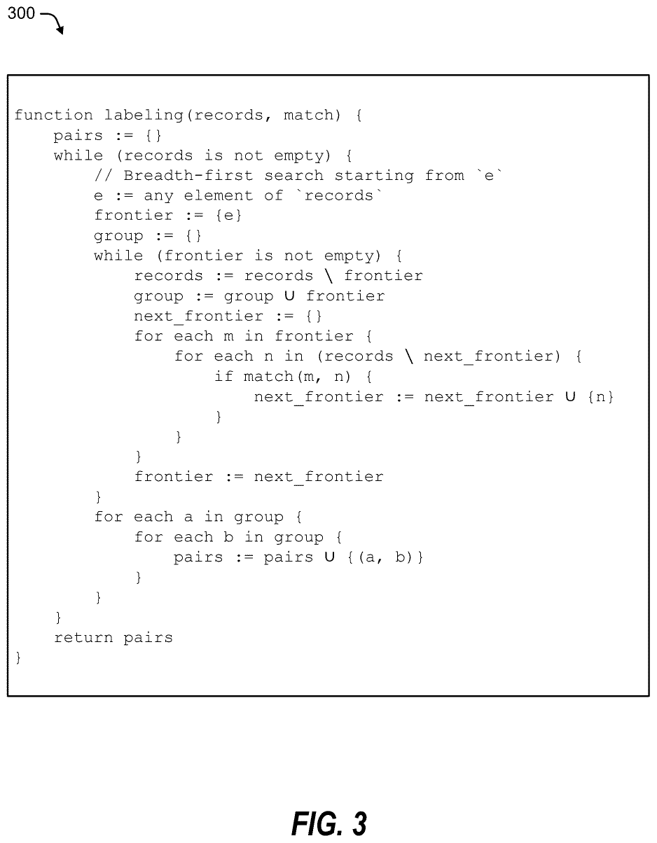

FIG. 3 is an example illustration of an algorithm 300 for computing transitive closure according to an illustrative embodiment. There are many algorithms for computing the transitive closure or the reflexive transitive closure. The algorithm 300 is a possible labeling algorithm, written in pseudocode, that produces the labeling via the reflexive transitive closure as a set of positive samples (ordered pairs of records). The “records” is a set of records and “match” is a matching function.

The algorithm 300 takes a set of records and a matching function and aims to produce first clusters of records that were matched by the matching function. To apply transitive closure the algorithm 300 starts with a seed record and attempts to find every record that can be reached in any number of steps from the seed record. The transitive closure connects all the records that can be reached from the seed record. The algorithm 300 starts with any element, such as record “e,” of the records. The while loop performs a breadth first search, such as outward through a graph, to find all reachable records that any number of hops from starting record “e,” where the matching function is positive for intervening pairs of records. The algorithm 300 then returns the pairs of records determined to correspond to the same entity through matching and transitive closure.

Any algorithm that produces the transitive closure over an input dataset can be used instead of the algorithm 300. In particular, some matching functions will permit computing the transitive closure with a specialized procedure with time complexity that is linear or quasi-linear in the number of paired records, where an example is given below. For large datasets, this can provide a dramatic speedup over the general algorithm given above, whose time complexity is quadratic in the number of records.

In the labeling procedure defined above, the matching function named “match” is provided as a parameter. In other words, if this pseudocode is translated to a programming language, the matching function can be chosen at runtime. In programming languages supporting higher-order functions, this is often straightforward to do. Alternatively, the labeling procedure can use a hard-coded match function or other match function.

The output labeling can also be computed in an incremental fashion, where new input records may be added after the algorithm has already run over an initial input dataset. The sample implementation above may not be suitable for this particular use case. In incremental computation, a new record can result in the addition of new pairs with positive labels, and in the addition or replacement of pairs of negative labels. Positive labels may never be removed.

Labeling Algorithm with Max_Hops Parameter

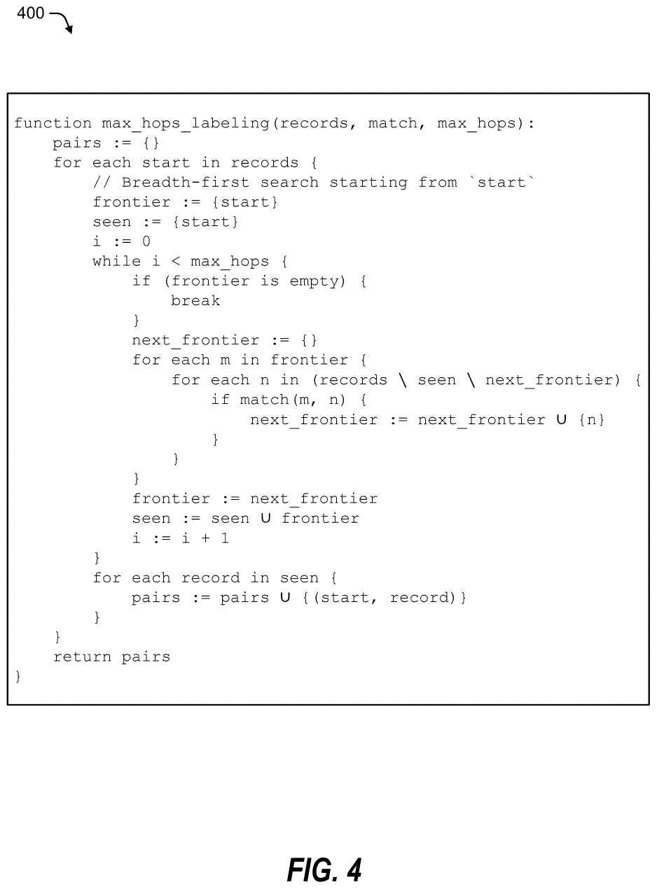

FIG. 4 is an example illustration of an algorithm 400 for computing a labeling with the max_hops parameter according to an illustrative embodiment. Like the labeling algorithm 300 described above, this example algorithm 400 makes use of a breadth-first search method. When max_hops is infinite, the algorithm 400 produces the same output as the labeling algorithm 300 described above. However, the algorithm 300 can be more efficient.

### Example Implementation

As discussed above, each record contains one or more attributes. For instance, if the entities are publications, each record can have the attributes “Title”, “Author Name”, Library of Congress Control Number “LCCN”, and International Standard Book Number “ISBN”. In this example, it is assumed that “Author Name”, “LCCN”, and “ISBN” may take on the value NULL, which means that the true value is unknown or does not exist. It is also assumed that a publication may have more than one correct LCCN, as well as more than one correct ISBN. The following data will be used as an example, where the data contains some misspellings.

Data source A has all the attributes:

| Title | Author Name | LCCN | ISBN |
|---|---|---|---|
| Pink Leaves of Ja | NULL | 2001-1114 | 123-4-56-123456-0 |
| Pink Leaves of Junary | Ralph D. | 2001-1114 | 789-7-89-789789-0 |
| | Wiggum | | |

Data Source B does not have the LCCN attribute:

| Title | Author Name | ISBN |
|---|---|---|
| Pink Leaves of January | R. Wiggum | 123-4-56-123456-0 |
| The Pink Leaves of January | Ralph Gregory | 789-7-89-789789-0 |
| Leave in January | Amanda Williams | NULL |

As a first step, these sources are combined. An arbitrary record index is assigned for explanatory purposes:

| Record | | | | |
|---|---|---|---|---|
| Index | Title | Author Name | LCCN | ISBN |
| 1 | Pink Leaves of Ja | NULL | 2001-1114 | 123-4-56-123456-0 |
| 2 | Pink Leaves of Junary | Ralph D. Wiggum | 2001-1114 | 789-7-89-789789-0 |
| 3 | Pink Leaves of January | R. Wiggum | NULL | 123-4-56-123456-0 |
| 4 | The Pink Leaves of January | Ralph Gregory | NULL | 789-7-89-789789-0 |
| 5 | Leave in January | Amanda Williams | NULL | NULL |

A matching function is defined that takes a pair of records A and B, each including “determiner attribute” values, and the matching function returns a Boolean result. The function should return TRUE if and only if the records are believed to belong to the same entity. The function should be conservative, that is, it should return FALSE if there is not enough information to make a confident judgement. In this example, the function is defined as below. For this example, a conscious decision is made to use only “LCCN” and “ISBN” in the matching function. The records match as belonging to the same entity if the same LCCN and/or ISBN exists for both records. Ignoring a subset of attributes in the matching function can have an advantage that will be explained below.

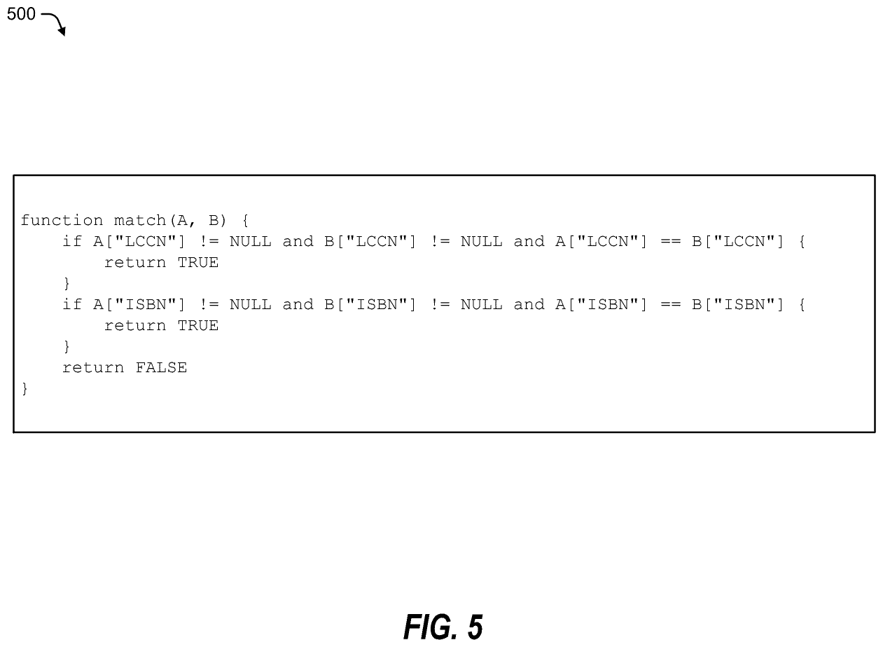

FIG. 5 is an example illustration of pseudocode 500 for the matching function according to an illustrative embodiment. When this matching function is applied to the records above, the unordered record pairs (1, 2), (1, 3), and (2, 4) are considered by the matching function to be matches. Also, each record except for record 5 is matched to itself. However, records (1, 4) are not considered a match by the matching function itself because the book has two different ISBNs.

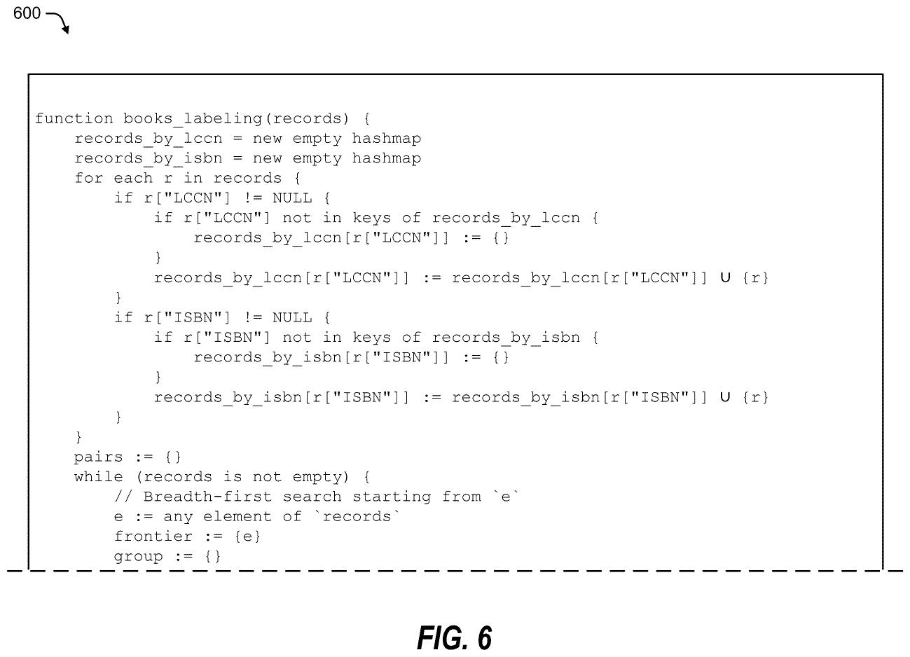

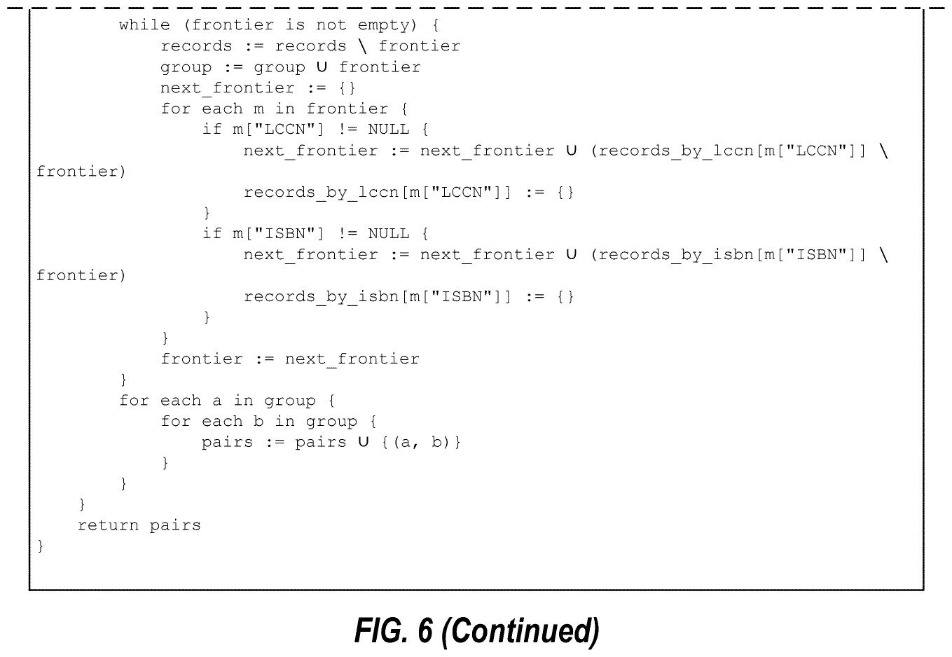

FIG. 6 is an example illustration of an algorithm 600 for building an index according to an illustrative embodiment. To apply the reflexive transitive closure and produce the labeling, the general algorithms given above, such as the algorithm 300, can be used. The algorithm 600 provides a specialized optimized algorithm that builds an index using hashmaps.

Either approach to building the reflexive transitive closure gives the same result, but for large datasets the specialized approach of the algorithm 600 can be significantly faster than the generic labeling algorithm given earlier. For example, the algorithm 600 incorporates the matching function to look at the attributes themselves to return transitive and functionally matched pairs of records that belong to the same entity. One group of records shares the same LCCN, another group shares the same ISBN, and the algorithm groups them all together. This can be more efficient because the matching function does not have to be called on each pair of records.

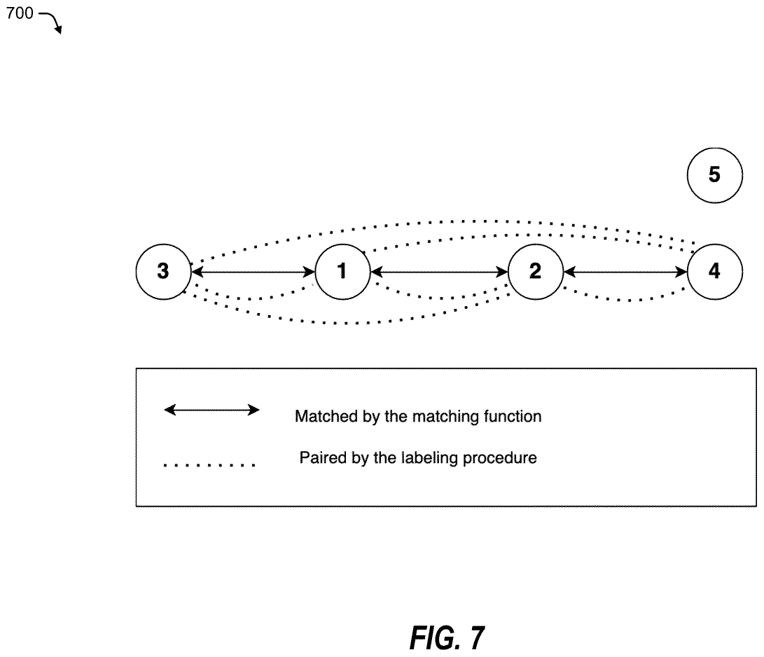

FIG. 7 is an example illustration of results 700 of a labeling procedure according to an illustrative embodiment. Applying the transitive closure adds positive labels for the matches produced by the matching function as well as (1, 4), (2, 3), and (3, 4). For example, the labeling procedure provides the missing link to pair records (1, 4) as a transitive pair of records that were not otherwise functionally matched by the matching function because they have different ISBNs. The output from the labeling procedure is shown below:

| Record Index | Record Index |
|---|---|
| 1 | 2 |
| 2 | 1 |
| 1 | 3 |
| 3 | 1 |
| 1 | 4 |
| 4 | 1 |
| 2 | 3 |
| 3 | 2 |
| 2 | 4 |
| 4 | 2 |
| 3 | 4 |
| 4 | 3 |
| 1 | 1 |
| 2 | 2 |
| 3 | 3 |
| 4 | 4 |
| 5 | 5 |

The last pair (5, 5) is included if use the reflexive transitive closure is used, but not if the transitive closure is used (the matching function does not match record 5 with itself). The difference between these two variants is typically of little practical significance.

The last five rows, where records are paired with themselves, are left out for the rest of this example because they are not helpful for most types of downstream tasks. The pairs will also be considered unordered, so (1, 2) and (2, 1) are considered to be the same pair, and the first of the two variants are kept. The table is thus shortened to the following table:

| Record Index | Record Index |
|---|---|
| 1 | 2 |
| 1 | 3 |
| 1 | 4 |
| 2 | 3 |
| 2 | 4 |
| 3 | 4 |

Avoiding Bias from the Matching Function

Generally speaking, the true positives in the labeling are only a subset of the pairs of records belonging to the same entity. The choice of matching function biases the statistical properties of this subset. For example, records where ISBN and LCCN are both NULL cannot be paired with other records in the labeling. This can lead to a lower rate of these kinds of records being present in the output labeling.

If an attribute is not used by the matching function, then its values in the labeling can only be biased indirectly via correlations with those attributes that are considered in the matching function. This can be useful for many downstream tasks, such as training a machine learning model from pairs of attributes. For example, the following table of matching book title variants can be produced from the labeling:

| Book Title | Book Title |
|---|---|
| Pink Leaves of Ja | Pink Leaves of Junary |
| Pink Leaves of Ja | Pink Leaves of January |
| Pink Leaves of Ja | The Pink Leaves of January |
| Pink Leaves of Junary | Pink Leaves of January |
| Pink Leaves of Junary | The Pink Leaves of January |
| Pink Leaves of January | The Pink Leaves of January |

This can be used to train a model that is supposed to recognize whether book title variants belong to the same book. The book titles have not been considered by a matching function. This is a helpful measure to ensure that a model is not simply trained to recognize the matching function's output.

As an example, if the matching function were to return TRUE for any pair of records where the book titles have a Levenshtein distance less than 3, this may produce an acceptably accurate labeling, even on a bigger dataset. However, it would be biased towards producing pairs with a low Levenshtein distance, which is undesirable when trying to train a “book title variant model”, which should be able to learn hidden, non-obvious patterns in the dataset. If the training is unbiased or at least less biased, the training outcome is generally improved, even if the avoidance of bias comes at the cost of less accurate training data.

### Extension Examples

Pairs with a negative label can be easily produced as shown in the table below using the extension described above:

| Book Title | Book Title |
|---|---|
| Pink Leaves of Ja | Leave in January |
| Pink Leaves of Junary | Leave in January |
| Pink Leaves of January | Leave in January |
| The Pink Leaves of January | Leave in January |

In typical large datasets, the number of pairs that could be given a negative label is far larger than the number of pairs with a positive label. For practical reasons, a random sample of pairs can be drawn with a negative label.

If desired, a confidence level can be output for each pair of records in the labeling. In this example, the confidence level is defined as 0.99 \hat{ }num_hops. This produces the results in the table below with the confidence rounded to 4 significant decimal digits. The confidence level can be used instead of the maximum number of hops because different matching functions may have different confidence levels, such as by producing more or less false positives.

There is an analogy between the maximum number of hops and the min_confidence parameter. A matching function can be defined in a way that matches records with different confidence levels. Defining the labeling procedure in terms of maximum hops is straightforward, but not as flexible and expressive. Different matching functions can be defined in ways that match records with different confidence levels. Ascribing different confidence levels to different matching functions can provide flexibility while using a static value for the min_confidence parameter. For example, matching based on a book identifier can provide more confidence than matching on author's name or title.

| Record Index | Record Index | Confidence |
|---|---|---|
| 1 | 2 | 0.9900 |
| 1 | 3 | 0.9900 |
| 1 | 4 | 0.9801 |
| 2 | 3 | 0.9801 |
| 2 | 4 | 0.9900 |
| 3 | 4 | 0.9703 |

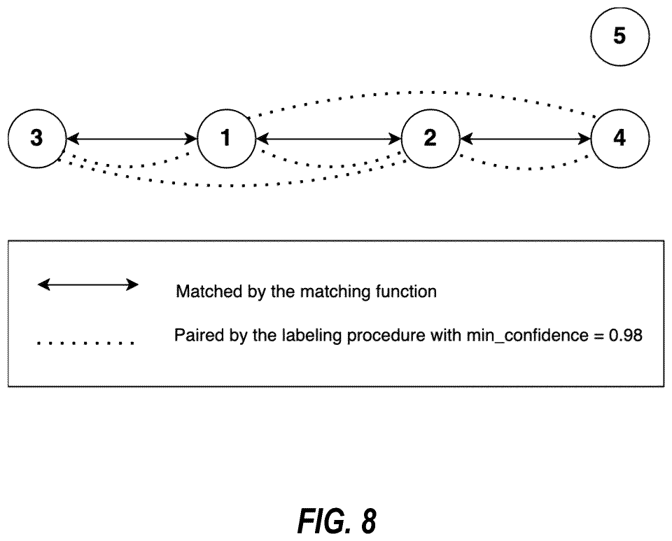

FIG. 8 is an example illustration of the results 800 of a labeling procedure of this implementation according to an illustrative embodiment. If min_confidence is set to 0.98, the last pair (3, 4) is excluded from the positive labels. Regardless of this, the pair is not considered to be a candidate for a negative label, due to its presence in the reflexive transitive closure.

### Methods for Evaluating Candidate Matching Functions and Other Configurable Parameters

A chosen matching function should have few false positive matches, where it is more acceptable to have a higher number of false negatives where it fails to match records. In practice, it may not be obvious what is a suitable matching function, or to find which of multiple matching functions is best. Besides careful consideration by domain experts with access to the dataset, techniques can be used to define the matching sampling quality, based on statistical reasoning.

A straightforward approach is for an expert to label relatively a small sample of pairs of records (for example, 400 pairs) to be used for evaluating candidate matching functions. However, this approach is not good for multiple reasons. First, a uniformly random sample of pairs, for typical datasets, includes almost entirely negative samples. At the same time, care must be taken to avoid bias in the sample, which would lead to a biased estimate of the accuracy of the candidates. Second, even a uniformly random sample of, for example, 200 positive pairs and 200 negative pairs, labeled by an expert, does not provide enough information about the suitability of a matching function. This is because a much larger sample size would be needed to reliably distinguish between a false positive rate of 0.1%, which may be unacceptably high, and an acceptable false positive rate of, for instance, 0.0001%. The false positive rate is defined as the number of false positives divided by the number of actual negatives (i.e., the number of true negative plus the number of false positives).

For example, assume a dataset with 100,000 records and therefore 10,000,000,000 pairs of records. Also assume that 100,000 pairs of records are true matches, i.e., they should be labeled positively. In this example, a false positive rate of 0.1% in the matching function means that false positives outnumber true positives by around 100:1 or more.

Therefore, it is useful to produce a larger random sample of pairs of records and run each candidate matching function over these pairs of records. This can determine whether the matching function is suitable by providing a fairly accurate estimate of the false positive rate and the rate of positives among all pairs of a matching function. Continuing the above example, a candidate matching function can be run over a random sample of 250,000,000 pairs of records. If the candidate function produces 800 positives, an expert can label a random sample of 200 of these pairs. If, for instance, 197 of the pairs are labeled as positive also by the expert, this can provide confidence that the true positives by far outnumber the false positives (even when accounting for the fact that an expert may also produce a wrong label in rare cases).

A similar approach can be used to compare different candidate functions. For example, assume there is a second candidate function that produces 1000 positive labels from the same sample of 250,000,000 pairs, 700 of which are also among the 800 pairs produced by the first candidate function. In this case, a human expert could carefully review the remaining 100 pairs that are labeled positively only by the first candidate, and 100 pairs randomly sampled from the 300 pairs that are labeled positively only by the second function, as well as 100 pairs randomly sampled from the 700 pairs that were labeled positively by both functions. The expert-provided labels can be used to estimate the ratio of false positives to true positives for each of the functions. The following table provides an example outcome.

| | Candidate 2 positive | Candidate 2 negative |
|---|---|---|
| Candidate 1 positive | 700 | 100 |
| | Expert positive: 99 | Expert positive: 95 |
| | Expert negative: 1 | Expert negative: 5 |
| Candidate 1 negative | 300 | (ignored) |
| | Expert positive: 96 | |
| | Expert negative: 4 | |

In this example, the first candidate function (candidate 1) is expected to have about 12 false negatives (700/100*1+100/100*5) per 800 positive labels, a ratio of 1.5%. The second candidate (candidate 2) is expected to have about 19 false negatives (700/100*1+300/100*4) per 1000 positive labels, a ratio of 1.9%. Therefore, the first candidate function can be expected to be marginally better suited for most tasks. For this example, a matching function that returns TRUE only if candidate 1 and candidate 2 both return TRUE can be used. This matching function can be expected to have about 7 false negatives per 700 positive labels, or 1.0%.

These estimates can be used to design a function that outputs the confidence level (one of the optional extensions described above). Using candidate 1, the confidence level of a matched pair (separated by “one hop”) is around 98.5%, or 0.985. It may be slightly lower to account for errors made by the expert. A function that outputs a confidence level of 0.985 \hat{ }num_hops is an appropriate default choice, as it follows naturally from a few simplifying assumptions (such as statistical independence of matching function mistakes).

Larger samples and more expert-provided labels can be used for higher statistical power. Also, the entire labeling can be produced using described embodiments and the above-described evaluation methods can be adapted to estimate the percentage of false negatives per positive label after applying the transitive closure. In this this variation the labeling procedure has to be run over the entire dataset, which may be computationally intensive, especially for large datasets.

When using the output of the labeling procedure for the evaluation steps, the above-described evaluation methods can be further adapted to empirically estimate values of the confidence level at two hops and more. They can also be used to optimize the value of the “max_hops” parameter or the “min_confidence” parameter, if such an extension is used. In this case, the need for a large training set can be balanced against the need for accuracy in the labels.

### Numerical Evaluation

In this section, the added value of the labeling procedure and the labels it generates are numerically evaluated. This is done by presenting three different scenarios in which the labeling can be used. The first scenario includes generating labels for a downstream task of training a name matching model. The second scenario includes generating labels for open-source datasets. The third scenario includes estimating the effort that a human labeler would require.

The results reported in the first and second scenarios are conceptually different. In the first scenario the quality of the downstream string-matching model that was trained on the produced labels is measured, whereas in in the second scenario the quality of the produced labels themselves is measured.

### Name Matcher Training

For name matcher training an entity resolution algorithm that relies heavily on a name matching approach is implemented. The goal is to develop a name matching approach that does not rely on any additional attributes, except the names themselves.

The initial approach is based on string similarity and is defined as follows: when presented with a pair of names, several string similarity metrics are computed, their average is taken, and a pre-defined threshold is applied. However, these names cannot always be captured using common string similarity approaches due to the different variations in which different names of one entity can appear. To be able to capture some of these variations, the labeling procedure is applied. The match function is defined to make use of unique record IDs, as well as additional secondary IDs, in order to identify clusters of ground truth clusters of records. The names of all records in a given cluster are considered to be essentially the same name. These labels are then used to train a very simple (2-layer) neural network, using the same string similarity metrics as input features.

The performance of these two approaches is reported on an internal hand-annotated evaluation dataset that consists of pairs of names with positive and negative matching labels, focusing on examples that are very hard. The positively labeled pairs make up 33.5% of the pairs.

| Approach | F1 Score |
|---|---|
| String Similarity | 51% |
| Trained Name Matcher (ours) | 64% |

### Open-Source Datasets

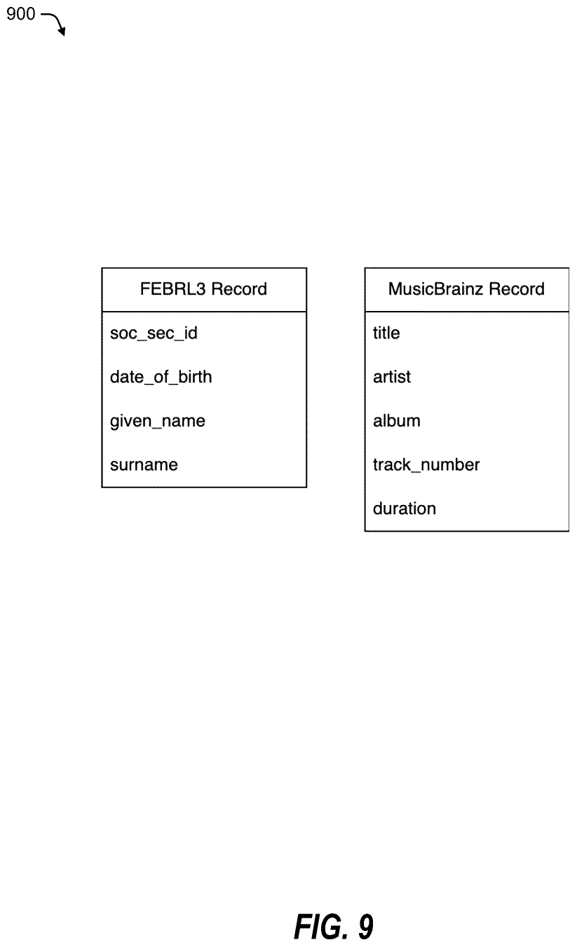

FIG. 9 is an example illustration of relevant attributes 900 of datasets according to an illustrative embodiment. The labeling procedure is also evaluated on two widely accepted open-source datasets for entity resolution and record linkage: FEBRL3 and MusicBrainz. Both datasets are based on a set of real records that are duplicated with a high degree of corruption to stress-test the downstream approaches. FEBRL3 is a dataset constructed by the developers of the Freely Extensible Biomedical Record Linkage (FEBRL) package. It includes 5000 records (2000 originals and 3000 duplicates), with a maximum of 5 duplicates based on one original record. MusicBrainz is a dataset based on real records of songs from the MusicBrainz database. The generated dataset consists of 20k records coming from five sources and contains duplicates for 50% of the original records in two to five sources.

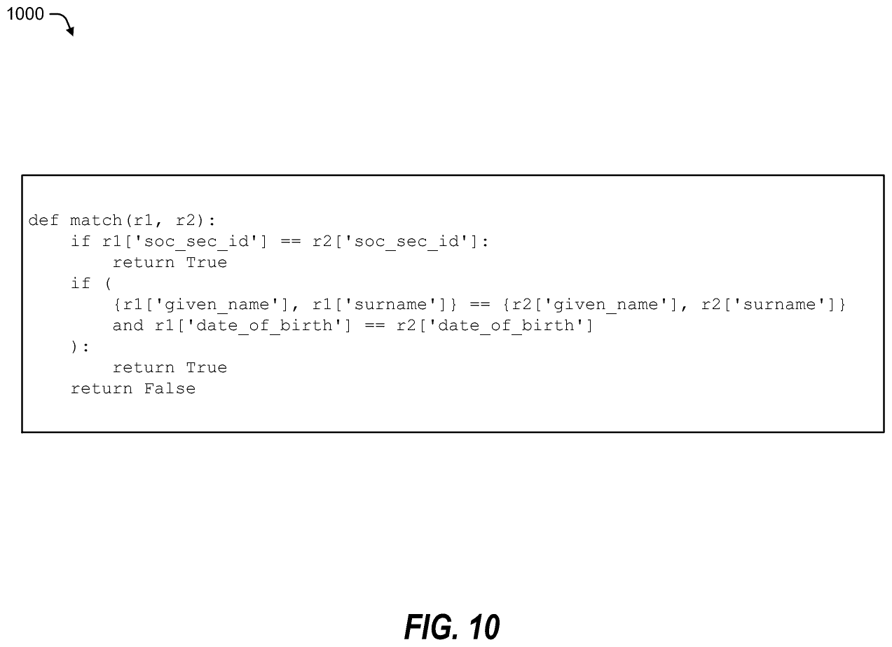

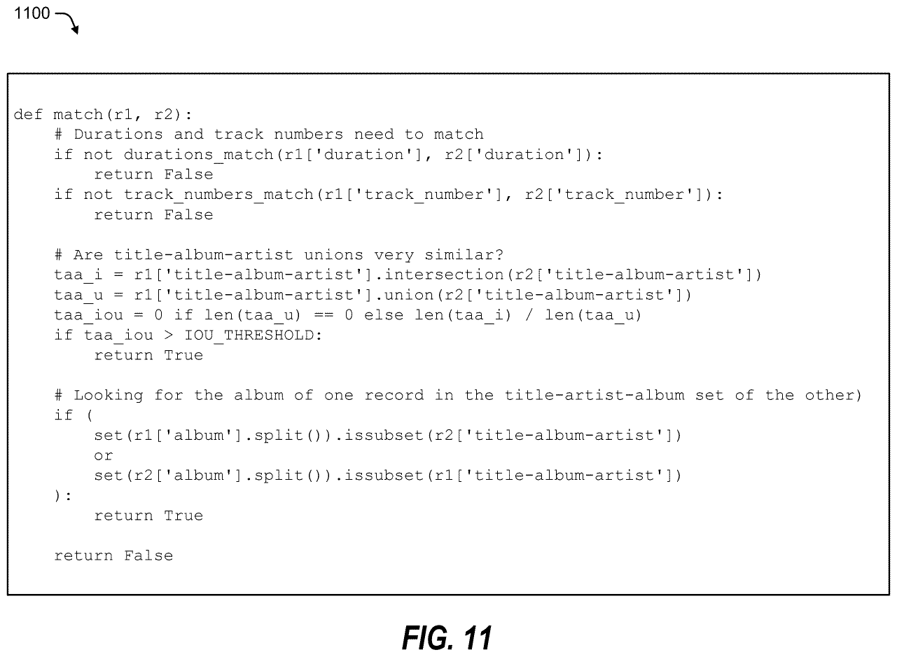

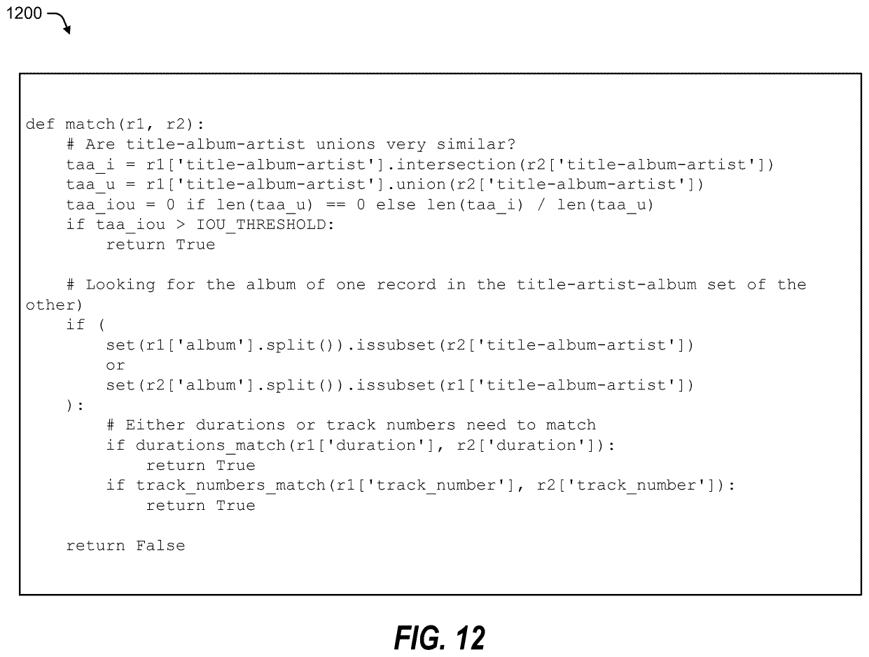

FIG. 10 is an example illustration of an algorithm 1000 for a simple and effective FEBRL3 matching function according to an illustrative embodiment. FIG. 11 is an example illustration of an algorithm 1100 for a simple and effective MusicBrainz matching function according to an illustrative embodiment. FIG. 12 is an example illustration of an algorithm 1200 for a less strict simple and effective MusicBrainz matching function according to an illustrative embodiment. The labeling procedure is run to obtain the labels, and the results are shown in the table below.

| Dataset | Precision | Recall |
|---|---|---|
| FEBRL3 | 100.0% | 93.5% |
| MusicBrainz | 100.0% | 52.5% |
| MusicBrainz (less strict matching) | 99.5% | 88.1% |

When evaluating the quality of the produced labels, it is essentially required to have a close to perfect precision score. This provides confidence to use these labels as ground truth labels for any downstream task. The recall metric is reported in order to provide insight into how many of these labels were left behind, as a trade-off between confidence in the quality of produced labels and their volume.

To better understand this trade-off, two matching functions, the algorithms 1100 and 1200, are defined for the MusicBrainz dataset, with different levels of strictness. The stricter function 1100 leads to the desired precision of 100% and a recall of around 50%. On the other hand, the less strict function 1200 improves the recall up to almost 90%, but at the expense of the precision not being perfect. Even though the drop in precision is only 0.5%, this presents a conceptual difference in what the labeling procedure produces. I.e., the labels may be less valuable as ground truth labels due to the drop in precision. For this reason, it is usually preferred to define the matching function in a stricter fashion.

Naturally, human-produced labels are not free of errors. It has been estimated that the human error rate (across 10 relevant datasets used in the study) was at least 3.3%. Thus, when attempting to get access to ground truth labels, defining a very strict matching function and using this labeling procedure can be more accurate when compared to human labeling.

### Labeling Feasibility

To estimate how much time a human labeler would need to perform the same task, achieving the same quality as disclosed embodiments of the labeling procedure (reported in the table above), some assumptions are made. The first assumption is it takes a human labeler on average 10 seconds per pair. The second assumption is the human labeler uses an automated ideal candidate finder that presents only the necessary candidate pairs to the labeler (i.e, the labeler needs to do the minimal amount of work possible). The third assumption is the human labeler has transitive closure that connects all the labels together in a desired way. Under these assumptions, the time estimates for a human labeler are shown below.

| | Number of | Number of Pairs | Human Labeler |
|---|---|---|---|
| Dataset | Records | to Annotate | Time Estimate |
| FEBRL3 | 5k | 2.8k | 8 h |
| MusicBrainz | 20k | 5.6k | 16 h |

An ideal candidate finder is unrealistic and therefore, it is expected that human labelers need to do more work than listed in this table. When analyzing this table, it is noted the disclosed labeling procedure completes the task in less than a couple of minutes for datasets of this size.

The amount of work done by human labeler scales with the size of the desired labeling. For larger datasets, the desired number of labels can easily be 100k or more. This makes the manual labeling approach costly. On the other hand, the disclosed labeling procedure scales well because it is fully automated, needing no additional human input beyond defining a matching function.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depend on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicted output. An error or variance between the predicted output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria are met.

In a software implementation, when a machine learning model is referred to as receiving an input, being executed, and/or generating an output or prediction, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of the best breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neurons.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N [L−1] and N [L], respectively, the dimensions of matrix W is N [L−1] columns and N [L] rows.

Biases for a particular layer L may also be stored in matrix B having one column with N [L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as a vector. Training data comprises multiple inputs, each being referred to as a sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Fewer neurons means fewer activation values need be computed, and/or fewer derivative values need be computed during training.

Properties of matrices used to implement a neural network correspond to neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in a matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that are not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix-based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depend on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occur as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2(1):1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

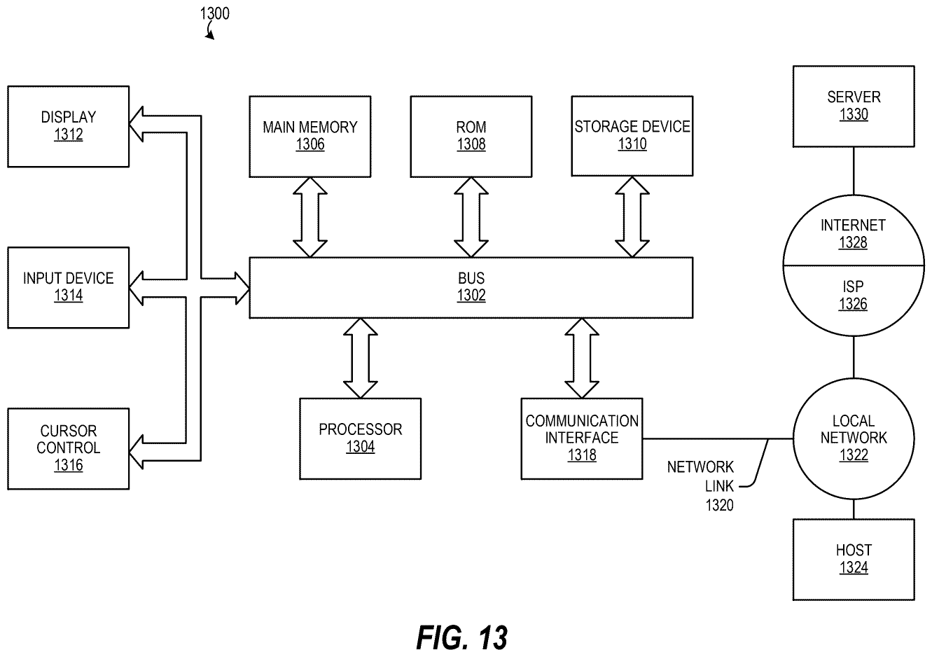

For example, FIG. 13 is a block diagram that illustrates a computer system 1300 upon which aspects of the illustrative embodiments may be implemented. Computer system 1300 includes a bus 1302 or other communication mechanism for communicating information, and a hardware processor 1304 coupled with bus 1302 for processing information. Hardware processor 1304 may be, for example, a general-purpose microprocessor.

Computer system 1300 also includes a main memory 1306, such as a random-access memory (RAM) or other dynamic storage device, coupled to bus 1302 for storing information and instructions to be executed by processor 1304. Main memory 1306 also may be used for storing temporary variables or other intermediate information during execution of instructions to be executed by processor 1304. Such instructions, when stored in non-transitory storage media accessible to processor 1304, render computer system 1300 into a special-purpose machine that is customized to perform the operations specified in the instructions.

Computer system 1300 further includes a read only memory (ROM) 1308 or other static storage device coupled to bus 1302 for storing static information and instructions for processor 1304. A storage device 1310, such as a magnetic disk, optical disk, or solid-state drive is provided and coupled to bus 1302 for storing information and instructions.

Computer system 1300 may be coupled via bus 1302 to a display 1312 for displaying information to a computer user. An input device 1314, including alphanumeric and other keys, is coupled to bus 1302 for communicating information and command selections to processor 1304. Another type of user input device is cursor control 1316, such as a mouse, a trackball, a touch screen, a track pad, and/or cursor direction keys for communicating direction information and command selections to processor 1304 and for controlling cursor movement on display 1312. This input device typically has two degrees of freedom in two axes, a first axis (e.g., x) and a second axis (e.g., y), that allows the device to specify positions in a plane.

Computer system 1300 may implement the techniques described herein using customized hard-wired logic, one or more ASICs or FPGAs, firmware and/or program logic which in combination with the computer system causes or programs computer system 1300 to be a special-purpose machine. According to one embodiment, the techniques herein are performed by computer system 1300 in response to processor 1304 executing one or more sequences of one or more instructions contained in main memory 1306. Such instructions may be read into main memory 1306 from another storage medium, such as storage device 1310. Execution of the sequences of instructions contained in main memory 1306 causes processor 1304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1310. Volatile media includes dynamic memory, such as main memory 1306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and/or any other storage media.

Storage media is distinct from but may be used in conjunction with transmission media. Transmission media participates in transferring information between storage media. For example, transmission media includes coaxial cables, copper wire and fiber optics, including the wires that comprise bus 1302. Transmission media can also take the form of acoustic or light waves, such as those generated during radio-wave and infra-red data communications.

Various forms of media may be involved in carrying one or more sequences of one or more instructions to processor 1304 for execution. For example, the instructions may initially be carried on a magnetic disk or solid-state drive of a remote computer. The remote computer can load the instructions into its dynamic memory and send the instructions over a telephone line using a modem or send the instructions using a network. A receiver, such as a modem, local to computer system 1300 can receive the data and use, for an example, an infra-red transmitter to convert the data to an infra-red signal. An infra-red detector can receive the data carried in the infra-red signal and appropriate circuitry can place the data on bus 1302. Bus 1302 carries the data to main memory 1306, from which processor 1304 retrieves and executes the instructions. The instructions received by main memory 1306 may optionally be stored on storage device 1310 either before or after execution by processor 1304.

Computer system 1300 also includes a communication interface 1318 coupled to bus 1302. Communication interface 1318 provides a two-way data communication coupling to a network link 1320 that is connected to a local network 1322. For example, communication interface 1318 may be an integrated services digital network (ISDN) card, cable modem, satellite modem, or a modem to provide a data communication connection to a corresponding type of telephone line. As another example, communication interface 1318 may be a local area network (LAN) card to provide a data communication connection to a compatible LAN. Wireless links may also be implemented, such as to a wireless local area network (WLAN) or to a cellular network. In any such implementation, communication interface 1318 sends and receives electrical, electromagnetic, radio, optical, and/or other signals that carry digital data streams representing various types of information.

Network link 1320 typically provides data communication through one or more networks to other data devices. For example, network link 1320 may provide a connection through local network 1322 to a host computer 1324 or to data equipment operated by an Internet Service Provider (ISP) 1326. ISP 1326 in turn provides data communication services through the world-wide packet data communication network now commonly referred to as the “Internet” 1328. Local network 1322 and Internet 1328 both use electrical, electromagnetic, or optical signals that carry digital data streams. The signals through the various networks and the signals on network link 1320 and through communication interface 1318, which carry the digital data to and from computer system 1300, are example forms of transmission media.

Computer system 1300 can send messages and receive data, including program code, through the network(s), network link 1320 and communication interface 1318. In the Internet example, a server 1330 might transmit a requested code for an application program through Internet 1328, ISP 1326, local network 1322 and communication interface 1318.

The received code may be executed by processor 1304 as it is received, and/or stored in storage device 1310, or other non-volatile storage for later execution.

### Software Overview

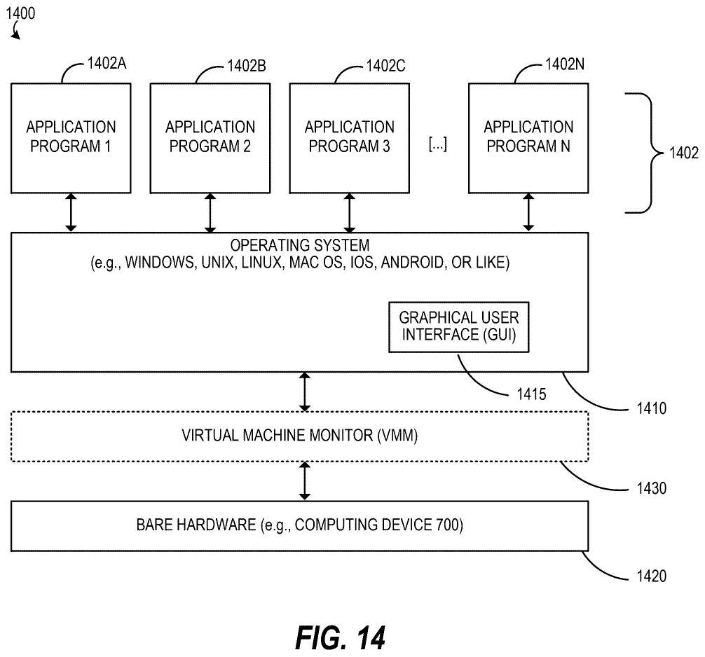

FIG. 14 is a block diagram of a basic software system 1400 that may be employed for controlling the operation of computer system 1300. Software system 1400 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1400 is provided for directing the operation of computer system 1300. Software system 1400, which may be stored in system memory (RAM) 1306 and on fixed storage (e.g., hard disk or flash memory) 1310, includes a kernel or operating system (OS) 1410.

The OS 1410 manages low-level aspects of computer operation, including managing execution of processes, memory allocation, file input and output (I/O), and device I/O. One or more application programs, represented as 1402A, 1402B, 1402C . . . 1402N, may be “loaded” (e.g., transferred from fixed storage 1310 into memory 1306) for execution by the system 1400. The applications or other software intended for use on computer system 1300 may also be stored as a set of downloadable computer-executable instructions, for example, for downloading and installation from an Internet location (e.g., a Web server, an app store, or other online service).

Software system 1400 includes a graphical user interface (GUI) 1415, for receiving user commands and data in a graphical (e.g., “point-and-click” or “touch gesture”) fashion. These inputs, in turn, may be acted upon by the system 1400 in accordance with instructions from operating system 1410 and/or application(s) 1402. The GUI 1415 also serves to display the results of operation from the OS 1410 and application(s) 1402, whereupon the user may supply additional inputs or terminate the session (e.g., log off).

OS 1410 can execute directly on the bare hardware 1420 (e.g., processor(s) 1304) of computer system 1300. Alternatively, a hypervisor or virtual machine monitor (VMM) 1430 may be interposed between the bare hardware 1420 and the OS 1410. In this configuration, VMM 1430 acts as a software “cushion” or virtualization layer between the OS 1410 and the bare hardware 1420 of the computer system 1300.

VMM 1430 instantiates and runs one or more virtual machine instances (“guest machines”). Each guest machine comprises a “guest” operating system, such as OS 1410, and one or more applications, such as application(s) 1402, designed to execute on the guest operating system. The VMM 1430 presents the guest operating systems with a virtual operating platform and manages the execution of the guest operating systems.

In some instances, the VMM 1430 may allow a guest operating system to run as if it is running on the bare hardware 1420 of computer system 1300 directly. In these instances, the same version of the guest operating system configured to execute on the bare hardware 1420 directly may also execute on VMM 1430 without modification or reconfiguration. In other words, VMM 1430 may provide full hardware and CPU virtualization to a guest operating system in some instances.

In other instances, a guest operating system may be specially designed or configured to execute on VMM 1430 for efficiency. In these instances, the guest operating system is “aware” that it executes on a virtual machine monitor. In other words, VMM 1430 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method comprising:
receiving a dataset of records as an input;
executing a labeling procedure that outputs a matched dataset of the received dataset, the matched dataset including functionally matched pairs of records, where a matching function determines that each functionally matched pair of records represent a respective same entity;
determining transitive pairs of records including a first record and a second record that belong to a same entity based on
the first record and a third record being one of the functionally matched pairs of records representing the same entity, and
the second record and the third record being another of the functionally matched pairs of records representing the same entity;
labeling the transitive pairs of records and functionally matched pairs of records as matched pairs of records based on the records belonging to the same respective entity; and
outputting the labeled matched pairs of records.

2. The method of claim 1, further comprising:
storing maximum number of hops value; and
limiting the transitive pairs of records to pairs of records that are that are connected by a number of matched pairs of records that is at most the maximum number of hops value.

3. The method of claim 1, further comprising:
determining a confidence level for pairs of records in the labeled matched pairs of records; and
outputting the confidence level for pairs of records in the labeled matched pairs of records.

4. The method of claim 1, further comprising:
providing an option for selection of the matching function; and
receiving an input selecting the matching function.

5. The method of claim 1, wherein the labeling comprises producing a ground truth labeling with a labeling that prioritizes minimizing false positive pairs of records over a complete labeling of all pairs of records.

6. The method of claim 1, further comprising estimating an accuracy of a machine learning entity resolution algorithm, where the estimated the accuracy is based on the labeled matched pairs of records.

7. The method of claim 1, wherein executing the labeling procedure comprises:
comparing, by the matching function, records in the received dataset;
providing, by the matching function, positive indications of pairs of records that belong to the same entity based on the comparing; and
outputting the matched dataset including the functionally matched pairs of records based on the positive indications of pairs records that belong to the same entity.

8. The method of claim 1,
wherein the transitive pairs of records include multiple-hop transitive pairs of records including a fourth pair of records determined to belong to the same entity based on multiple hops along a matched record chain including:
matched pairs of records that belong to the same entity, and
at least one transitive pair of records that belong to the same entity,
wherein the at least one transitive pair of records is different from the fourth pair of records.

9. The method of claim 1, further comprising:
selecting, from the dataset of records, pairs of records that are not matched in the transitive pairs of records and the functionally matched pairs of records; and
assigning a negative label to the selected pairs records indicating the selected pairs of records are not matched pairs of records.

10. One or more non-transitory computer-readable media storing one or more sequences of instructions which, when executed by one or more computing devices, cause:
receiving a dataset of records as an input;
executing a labeling procedure that outputs a matched dataset of the received dataset, the matched dataset including functionally matched pairs of records, where a matching function determines that each functionally matched pair of records represent a respective same entity;
determining transitive pairs of records including a first record and a second record that belong to a same entity based on
the first record and a third record being one of the functionally matched pairs of records representing the same entity, and
the second record and the third record being another of the functionally matched pairs of records representing the same entity;
labeling the transitive pairs of records and functionally matched pairs of records as matched pairs of records based on the records belonging to the same respective entity; and
outputting the labeled matched pairs of records.

11. The one or more non-transitory computer-readable media of claim 10, wherein the instructions include instructions for:
storing maximum number of hops value; and
limiting the transitive pairs of records to pairs of records that are & connected by a number of matched pairs of records that is at most the maximum number of hops value.

12. The one or more non-transitory computer-readable media of claim 10, wherein the instructions include instructions for:
determining a confidence level for pairs of records in the labeled matched pairs of records; and
outputting the confidence level for pairs of records in the labeled matched pairs of records.

13. The one or more non-transitory computer-readable media of claim 10, wherein the instructions include instructions for:
providing an option for selection of the matching function; and
receiving an input selecting the matching function.

14. The one or more non-transitory computer-readable media of claim 10, wherein the labeling comprises producing a ground truth labeling with a labeling that prioritizes minimizing false positive pairs of records over a complete labeling of all pairs of records.

15. The one or more non-transitory computer-readable media of claim 10, further comprising estimating an accuracy of a machine learning entity resolution algorithm, where the estimated the accuracy is based on the labeled matched pairs of records.

16. The one or more non-transitory computer-readable media of claim 10, wherein executing the labeling procedure comprises:
comparing, by the matching function, records in the received dataset;
providing, by the matching function, positive indications of pairs of records that belong to the same entity based on the comparing; and
outputting the matched dataset including the functionally matched pairs of records based on the positive indications of pairs records that belong to the same entity.

17. The one or more non-transitory computer-readable media of claim 10,
wherein the transitive pairs of records include multiple-hop transitive pairs of records including a fourth pair of records determined to belong to the same entity based on multiple hops along a matched record chain including:
matched pairs of records that belong to the same entity, and
at least one transitive pair of records that belong to the same entity,
wherein the at least one transitive pair of records is different from the fourth pair of records.

18. The one or more non-transitory computer-readable media of claim 10, wherein the instructions include instructions for:
selecting, from the dataset of records, pairs of records that are not matched in the transitive pairs of records and the functionally matched pairs of records; and
assigning a negative label to the selected pairs records indicating the selected pairs of records are not matched pairs of records.

19. A system comprising:
one or more processors; and
one or more storage media storing instructions which, when executed by the one or more processors, cause:
receiving a dataset of records as an input;
executing a labeling procedure that outputs a matched dataset of the received dataset, the matched dataset including functionally matched pairs of records, where a matching function determines that each functionally matched pair of records represent a respective same entity;
determining transitive pairs of records including a first record and a second record that belong to a same entity based on
the first record and a third record being one of the functionally matched pairs of records representing the same entity, and
the second record and the third record being another of the functionally matched pairs of records representing the same entity;
labeling the transitive pairs of records and functionally matched pairs of records as matched pairs of records based on the records belonging to the same respective entity; and
outputting the labeled matched pairs of records.

20. The method of claim 1,
wherein determining transitive pairs of records comprises determining transitive pairs of records including a first record and a second record that belong to a same entity by:
identifying the first record and the third record of the functionally matched pairs of records as representing the same entity; and
identifying the second record and the third record of the functionally matched pairs of records as representing the same entity, and
wherein outputting the labeled matched pairs of records comprises outputting a list of matched pairs of records.
